(19) United States
(12) Patent Application Publication
(10) Pub. No.: US 2020/0306707 A1
(43) Pub. Date: Oct. 1, 2020

(54) KNEADING DEVICE CAPABLE OF DETECTING PRESSURE AND DISPERSION DEGREE

(71) Applicant: NIHON SPINDLE MANUFACTURING CO., LTD., Hyogo (JP)

(72) Inventors: Hisashi Saito, Hyogo (JP); Takamasa Kishima, Hyogo (JP)

(21) Appl. No.: 16/793,691

(22) Filed: Feb. 18, 2020

(30) Foreign Application Priority Data
Mar. 29, 2019 (JP) 2019-069441

(51) Int. Cl. B01F 15/00; B01F 7/00; B01F 7/16; B01F 15/06

(52) U.S. Cl. CPC B01F 15/00162; B01F 15/00227; B01F 15/00175; B01F 7/00291; B01F 2215/0032; B01F 15/065; B01F 2015/061; B01F 2215/0049; B01F 7/1665

(57) ABSTRACT

There is provided a kneading device for dispersing a dispersoid in a non-conductive material. The kneading device includes a pressure measurement unit that has a pressure receiving portion which comes into contact with a kneading substance formed of the non-conductive material and the dispersoid, and that measures a pressure value applied to the kneading substance formed of the non-conductive material and the dispersoid, and a determination unit that determines a dispersed state of the dispersoid dispersed in the non-conductive material, based on the pressure value measured by the pressure measurement unit.

### RELATED APPLICATIONS

The content of Japanese Patent Application No. 2019-069441, on the basis of which priority benefits are claimed in an accompanying application data sheet, is in its entirety incorporated herein by reference.

### BACKGROUND

### Technical Field

Certain embodiments of the present invention relate to a kneading device for uniformly mixing two or more substances in various fields such as a chemical industry, a plastics industry, and a pharmaceutical industry.

### Description of Related Art

A kneading device has been widely used. For example, when rubber products are manufactured, a sealed type kneading device is used for a process in which raw rubber and an additive such as an additive compounding agent and a filler are mixed and kneaded into compounded rubber. For example, the related art discloses a horizontally biaxial kneading device as follows. Two mixing chambers are juxtaposed with each other, and mixing spaces thereof are connected to each other via a region below a ram and above abridge. The two mixing chambers are internally equipped with a plurality of rotor blades respectively having a characteristic shape. In the horizontally biaxial kneading device, rotors are disposed to be parallel to each other and rotatable. The rotors are rotated in directions opposite to each other, thereby enabling a kneading substance to be delivered between the mixing spaces.

### SUMMARY

According to an aspect of the present invention, there is provided a kneading device for dispersing a dispersoid in a non-conductive material. The kneading device includes a pressure measurement unit that has a pressure receiving portion which comes into contact with a kneading substance formed of the non-conductive material and the dispersoid, and that measures a pressure value applied to the kneading substance formed of the non-conductive material and the dispersoid, and a determination unit that determines a dispersed state of the dispersoid dispersed in the non-conductive material, based on the pressure value measured by the pressure measurement unit.

According to another aspect of the present invention, there is provided a manufacturing method of a kneading substance in which a dispersoid is dispersed in a non-conductive material. The manufacturing method includes a pressure measurement step of measuring a pressure value applied to the kneading substance formed of the non-conductive material and the dispersoid, and a determination step of determining a dispersed state of the dispersoid dispersed in the non-conductive material, based on the pressure value measured in the pressure measurement step.

### BRIEF DESCRIPTION OF THE DRAWINGS

FIGS. 1A and 1B are schematic views for describing a structure of a kneading device according to an embodiment of the present invention. FIG. 1A is a front sectional view of the kneading device. FIG. 1B is a plan view of the kneading device.

FIG. 2 is a schematic view for describing a structure of a pressure measurement unit attached to the kneading device according to the embodiment of the present invention.

FIG. 3 is a schematic view for describing a structure of an electrical characteristic measurement unit attached to the kneading device according to the embodiment of the present invention. FIG. 3 illustrates an example of the electrical characteristic measurement unit where an electrode portion is flush with an inner surface of a mixing chamber.

FIGS. 4A and 4B are schematic views for describing another aspect of the electrical characteristic measurement unit attached to the kneading device of the present invention. FIG. 4A is a schematic view for describing the electrical characteristic measurement unit having a shape in which the electrode portion protrudes to the mixing chamber side. FIG. 4B is a schematic view for describing the electrical characteristic measurement unit having a shape in which the electrode portion is retreated to a casing outer wall side.

FIGS. 5A and 5B are schematic views for describing disposition of the pressure measurement unit and the electrical characteristic measurement unit which are attached to the kneading device of the present invention. FIG. 5A is a schematic view for describing the kneading device where the pressure measurement unit and the electrical characteristic measurement unit are disposed on a curved surface portion. FIG. 5B is a schematic view for describing the kneading device where the pressure measurement unit and the electrical characteristic measurement unit are disposed on a planar portion.

FIGS. 6A and 6B are schematic views for describing a structure of a compound measurement unit attached to a kneading device according to another embodiment of the present invention. FIG. 6A is a front sectional view of the compound measurement unit attached to the kneading device. FIG. 6B is a plan view of the compound measurement unit attached to the kneading device.

FIGS. 7A and 7B are schematic views for describing another aspect of the compound measurement unit. FIG. 7A is a plan view in a case where a pressure receiving portion of the compound measurement unit is set to have a substantially quadrangular prismatic shape, and a first electrode, a second electrode, and an insulating member are set to have a substantially quadrangular cylinder shape. FIG. 7B is a plan view in a case where the pressure receiving portion of the compound measurement unit is set to have a substantially quadrangular prismatic shape, and the first electrode, the second electrode, and the insulating member are set to have a substantially circular cylinder shape.

### DETAILED DESCRIPTION

In kneading rubber, it is necessary to finely and uniformly disperse an additive to a rubber raw material. Poor dispersion degrades quality of a rubber product. Therefore, a sealed type kneading device is managed to measure externally observable values such as a kneading time, a kneading device internal temperature, power consumption, and a ram position. A kneading process is completed when the values reach predetermined values. Through this management, product quality is maintained at a constant level. However, the values indirectly show only a state of the kneading substance. Accordingly, an operator cannot recognize an actual state of the kneading substance. On the other hand, as a method of directly confirming a state of the kneading substance, the following method is known. The sealed type kneading device is opened and closed to sample a portion of the kneading substance, and a predetermined test is performed on the sampled kneading substance. However, it is not desirable in terms of work efficiency.

Accordingly, as the kneading device, the kneading device needs to be capable of accurately confirming a state of the kneading substance without sampling the kneading substance. That is, it is desirable to provide the kneading device capable of accurately confirming a state of the kneading substance inside the kneading device even during a kneading process.

The present inventor has intensively studied the above-described phenomenons. As a result, the present inventor completes the invention after finding the followings. It is possible to accurately determine a dispersed state of a dispersoid in a kneading substance formed of a non-conductive material and the dispersoid, based on a pressure value applied to the kneading substance inside a kneading device. That is, the present invention relates to a kneading device and a manufacturing method of a kneading substance which are described below.

In the kneading substance containing the dispersoid, an index indicating the dispersed state of the dispersoid varies depending on the pressure value applied to the kneading substance. Therefore, according to the above-described kneading device, the dispersed state of the dispersoid in the kneading substance is determined, based on the pressure value applied to the kneading substance. Accordingly, the dispersed state of the kneading substance is accurately determined.

Furthermore, according to the aspect of the kneading device of the present invention, the dispersoid may be conductive. The kneading device may further include an electrical characteristic measurement unit that has an electrode portion which comes into contact with the kneading substance formed of the non-conductive material and the conductive dispersoid, and a voltage application portion which applies a predetermined measuring voltage between a pair of electrodes belong to the electrode portion, and that measures an electrical characteristic value of the kneading substance. The determination unit may determine the dispersed state of the conductive dispersoid dispersed in the non-conductive material so that a relationship between the electrical characteristic value measured by the electrical characteristic measurement unit and the dispersed state is corrected using the pressure value measured by the pressure measurement unit. In the kneading substance containing the conductive dispersoid, an index indicating the dispersed state of the dispersoid varies depending on the pressure value applied to the kneading substance. Therefore, according to the above-described characteristic, the electrical characteristic value of the kneading substance containing the conductive dispersoid is measured, and the dispersed state of the conductive dispersoid contained in the kneading substance is measured, based on the electrical characteristic value. In this manner, the dispersed state of the kneading substance can be directly and accurately confirmed by performing correction using the pressure value measured by the pressure measurement unit.

Furthermore, according to the aspect of the kneading device of the present invention, the kneading device may further include a temperature measurement unit that has a heat sensitive portion which comes into contact with the kneading substance formed of the non-conductive material and the conductive dispersoid, and that measures a temperature value applied to the kneading substance formed of the non-conductive material and the conductive dispersoid. The determination unit may determine the dispersed state of the conductive dispersoid dispersed in the non-conductive material so that a relationship between the electrical characteristic value measured by the electrical characteristic measurement unit and the dispersed state is corrected using the pressure value measured by the pressure measurement unit and the temperature value measured by the temperature measurement unit. In the kneading substance containing the conductive dispersoid, an index indicating the dispersed state of the dispersoid varies depending on the temperature value applied to the kneading substance. Therefore, according to the above-described characteristic, the electrical characteristic value of the kneading substance containing the conductive dispersoid is measured, and the dispersed state of the conductive dispersoid contained in the kneading substance is measured, based on the electrical characteristic value. In this manner, the dispersed state of the kneading substance can be directly and accurately confirmed by performing correction using the pressure value measured by the pressure measurement unit and the temperature value measured by the temperature measurement unit.

Furthermore, according to the aspect of the kneading device of the present invention, the electrical characteristic measurement unit and the pressure measurement unit may be disposed close to each other. When the electrical characteristic measurement unit that measures the electrical characteristic value of the kneading substance and the pressure measurement unit that measures the pressure value applied to the kneading substance are disposed at separate positions inside the kneading device, there is a possibility that the electrical characteristic value and the pressure value may be measured for the kneading substances indifferent states. According to the kneading device, the electrical characteristic measurement unit and the pressure measurement unit are disposed close to each other. Therefore, the electrical characteristic value and the pressure value can be measured for the kneading substance in the same or similar state. Therefore, the kneading device is properly corrected when the electrical characteristic value is corrected using the pressure value. Accordingly, there is an advantageous effect in that the dispersed state of the kneading substance can be more accurately determined.

Furthermore, according to the aspect of the kneading device of the present invention, a shape of the electrode portion may be cylindrical, and the pressure receiving portion may be disposed inside the cylindrical electrode portion. According to the kneading device, portions for measuring the pressure value and the electrical characteristic value are disposed in a limited area. In this manner, the pressure value and the electrical characteristic value can be measured at the same location of the kneading substance. Therefore, the kneading device is properly corrected when the electrical characteristic value is corrected using the pressure value. Accordingly, there is an advantageous effect in that the dispersed state of the kneading substance can be more accurately determined.

According to the manufacturing method of the kneading substance, the dispersed state of the conductive dispersoid contained in the kneading substance is determined, based on the pressure value applied to the kneading substance. Therefore, the dispersed state of the kneading substance can be accurately determined.

It is possible to provide the kneading device capable of accurately and directly confirming the state of the kneading substance inside the kneading device even during the kneading process.

Hereinafter, embodiments of a kneading device according to the present invention will be described in detail with reference to the drawings. The kneading device described in the embodiments is merely an example for describing the kneading device according to the present invention, and the present invention is not limited thereto. The description of the kneading device in the following embodiments can be replaced with the description of each step according to a manufacturing method of the kneading substance corresponding thereto.

The kneading device of the present invention disperses a dispersoid to a non-conductive material. The non-conductive material is not particularly limited. For example, the non-conductive material includes a polymer material such as a rubber product, a plastic product, and a film. The dispersoid according to the present invention is a granular substance, and may be a non-conductive dispersoid or a conductive dispersoid. For example, the non-conductive dispersoid includes a silica particle and a sulfur particle. For example, the conductive dispersoid includes a carbon particle and metal powder.

### Embodiment

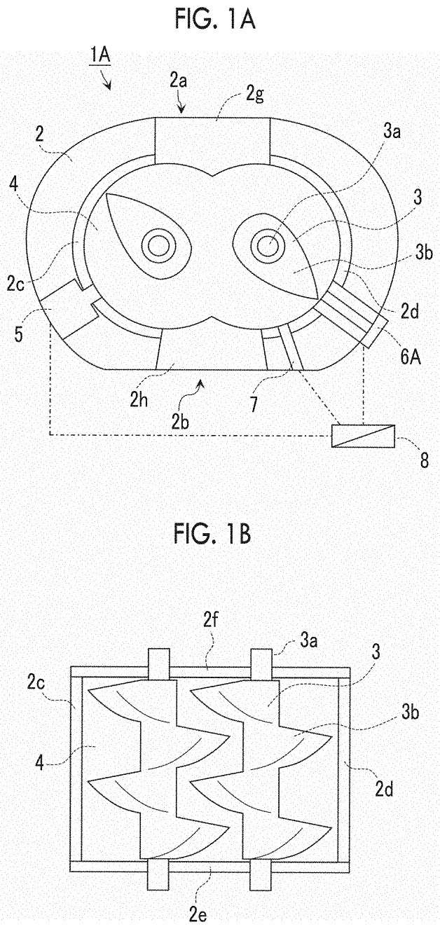

FIGS. 1A and 1B are schematic views for describing a structure of a kneading device 1A according to an embodiment of the present invention. A dashed line in FIG. 1A indicates electrical connection of each portion. In the embodiment, a resin used for a rubber product which serves as the non-conductive material and a conductive carbon particle serving as the dispersoid are kneaded.

As illustrated in FIG. 1A, a main part of the kneading device 1A includes a casing 2 that internally accommodates the non-conductive material such as a polymer material and the dispersoid, a pair of rotors 3 disposed inside the casing 2, a pressure measurement unit 5 and an electrical characteristic measurement unit 6 which are disposed in the casing 2, and a determination unit 8 disposed outside the casing 2 and to which the pressure measurement unit 5 and the electrical characteristic measurement unit 6 are electrically connected. In some cases, the non-conductive material and the dispersoid may be collectively referred to as a “kneading material” or a “kneading substance”.

As illustrated in FIGS. 1A and 1B, the casing 2 has a mixing chamber 4 surrounded by a semi-cylindrical left wall portion 2c, a semi-cylindrical right wall portion 2d, a front wall portion 2e, and a rear wall portion 2f. A top surface of the mixing chamber 4 has an input port 2a for inputting the kneading material, and a bottom surface of the mixing chamber 4 has a discharge port 2b for discharging the kneading substance. The input port 2a and the discharge port 2b respectively include an input port lid portion 2g and a discharge port lid portion 2h, and thus, the mixing chamber 4 can be sealed. Each inner surface shape of the input port lid portion 2g and the discharge port lid portion 2h is formed into a semi-circular shape together with each inner surface shape of the semi-cylindrical left wall portion 2c and the semi-cylindrical right wall portion 2d. The semi-cylindrical left wall portion 2c and the semi-cylindrical right wall portion 2d are portions that cover the pair of rotors 3 in the casing 2. The front wall portion 2e and the rear wall portion 2f are disposed to be orthogonal to a shaft portion 3a of the rotor 3 in the casing 2. The inner surface shape of the casing 2 is appropriately determined in accordance with a shape of a blade portion 3b of the rotor 3. The inner surface shape of the input port lid portion or the discharge port lid portion is appropriately determined in accordance with an installation position. For example, in a case where the input port lid portion is disposed on the top surface of the casing 2, the inner surface shape may be a flat shape.

The input port lid portion 2g is disposed to be movable upward and downward of the casing 2. In a state where an upper portion of the casing 2 is opened by moving the input port lid portion 2g upward, the non-conductive material and the conductive dispersoid are input to the mixing chamber 4 as the kneading material. Then, the input port lid portion 2g is moved downward so as to seal the mixing chamber 4. The kneading material is kneaded by rotating the rotor 3 in a state where the mixing chamber 4 is sealed. During the kneading, the input port lid portion 2g can be pressurized in a direction of the mixing chamber 4 by using a driving device such as an air cylinder. When the non-conductive material and the conductive dispersoid are mixed, the obtained kneading substance is discharged from the discharge port 2b. The discharge port lid portion 2h is installed in the casing 2 in a state where the discharge port 2b can be opened and closed.

The rotor 3 has the shaft portion 3a and the blade portion 3b formed on a surface of the shaft portion 3a. The blade portion 3b is spirally formed along the shaft portion 3a inside the mixing chamber 4. The rotor 3 is rotated to perform kneading by a rotor driving device (not illustrated) such as an electric motor. A rotation direction or a rotation speed of the rotor 3 is not particularly limited as long as the kneading can be sufficiently performed. For example, the rotor 3 may be rotated using a non-meshing type which rotates the pair of rotors 3 in mutually different directions, or may be rotated using a meshing type which rotates the pair of rotors 3 in the same direction. A size or a shape of the blade of the blade portion 3b and a cycle of a spiral structure may be optionally selected as long as the kneading can be sufficiently performed by optimizing a flow behavior of the kneading material inside the mixing chamber 4.

When the kneading is performed using the rotor 3, heat may be generated due to shearing or deformation of the kneading substance, and the kneading substance may become hot. When the kneading substance becomes hot, there is a possibility that quality of the kneading substance may be degraded. Therefore, a temperature control mechanism for controlling the temperature inside the mixing chamber 4 may be installed therein. The temperature control mechanism may include means for indirectly cooling the kneading substance by circulating a refrigerant through a jacket disposed on an outer peripheral surface of the casing or a cavity formed inside the rotor, and means for directly cooling the kneading substance by circulating cold air inside the mixing chamber 4.

### Pressure Measurement Unit

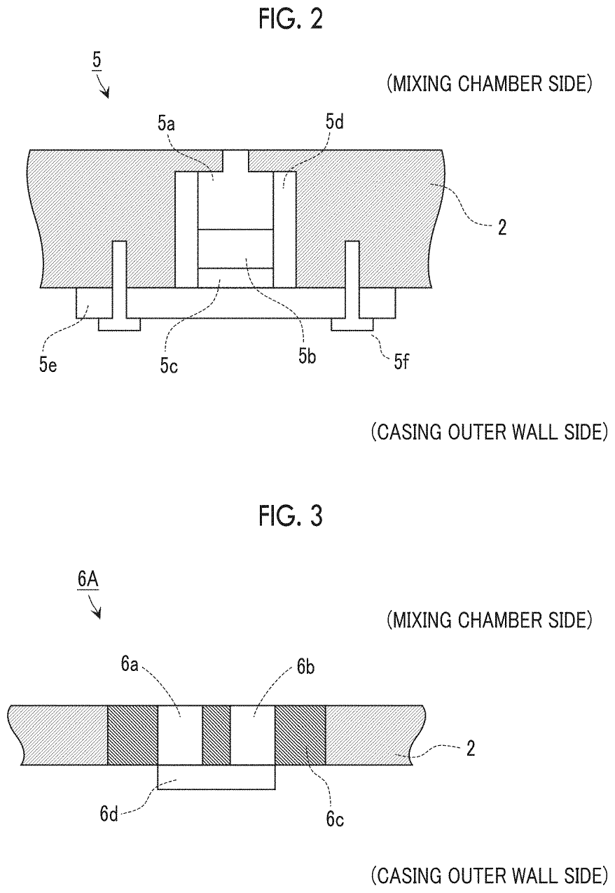

FIG. 2 is a sectional view for describing a structure of the pressure measurement unit 5. In the pressure measurement unit 5, a pressure receiving portion 5a is disposed at a place where a mixing chamber side surface of the casing 2 comes into contact with the kneading substance. A lower portion of the pressure measurement unit 5 includes a buffering portion 5b, a pressure sensor 5c, and a guide 5d that surrounds peripheries thereof. The pressure measurement unit 5 is fixed to the casing 2 by using a presser plate 5e and a bolt 5f.

In the pressure measurement unit 5, the pressure sensor 5c senses the pressure generated when the kneading substance comes into contact with the pressure receiving portion 5a during the kneading via the buffering portion 5b. A pressure value of the kneading substance is constant as the kneading substance is kneaded in a smooth state. Accordingly, a dispersed state of the kneading substance can be confirmed by the pressure measurement unit 5 sensing the pressure.

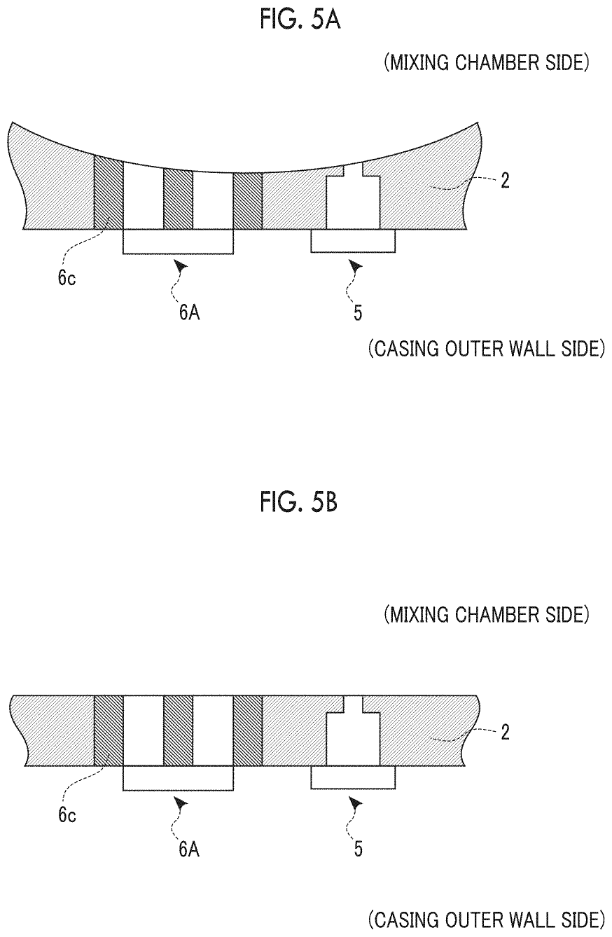

An installation place or the number of installed pressure measurement units 5 is not particularly limited. The installation place is disposed in at least one of the input port lid portion 2g, the discharge port lid portion 2h, the semi-cylindrical left wall portion 2c, the semi-cylindrical right wall portion 2d, the front wall portion 2e, and the rear wall portion 2f of the casing 2. For example, as illustrated in FIG. 5A, the installation place of the pressure measurement unit 5 maybe a curved surface portion on the mixing chamber side surface in the input port lid portion 2g, the discharge port lid portion 2h, the semi-cylindrical left wall portion 2c, and the semi-cylindrical right wall portion 2d of the casing 2. Alternatively, as illustrated in FIG. 5B, the installation place of the pressure measurement unit 5 may be a planar portion on the mixing chamber side surface in the front wall portion 2e and the rear wall portion 2f of the casing 2. The kneading substance is pressed against the curved surface portion by the rotation of the rotor 3. Accordingly, the pressure applied to the kneading substance can be more properly indicated by installing the pressure measurement unit 5 in the curved surface portion.

### Temperature Measurement Unit

The temperature measurement unit 7 is disposed to be in contact with the kneading substance on the mixing chamber side surface of the casing 2. The temperature measurement unit 7 transmits the temperature detected in the heat sensitive portion which comes into contact with the kneading substance, to the determination unit 8.

An installation place or the number of installed temperature measurement units 7 is not particularly limited. The installation place is disposed in at least one of the input port lid portion 2g, the discharge port lid portion 2h, the semi-cylindrical left wall portion 2c, the semi-cylindrical right wall portion 2d, the front wall portion 2e, and the rear wall portion 2f of the casing 2. Based on the temperature measured by the temperature measurement unit 7, it is possible to correct an electric resistance value that decreases due to the raised temperature. It is desirable to install the temperature measurement unit 7 in the vicinity of the pressure measurement unit 5 in order to more accurately determine a dispersed state of the kneading substance.

### Electrical Characteristic Measurement Unit

FIG. 3 is a schematic view for describing a structure of the electrical characteristic measurement unit 6. The electrical characteristic measurement unit 6 includes a pair of electrodes (first electrode portion 6a and second electrode portion 6b) installed at places where the mixing chamber side surface of the casing 2 comes into contact with the kneading substance, and a voltage application portion 6d for applying a measuring voltage between the electrodes. As illustrated in FIG. 3, the electrical characteristic measurement unit 6 is configured to have an insulating member 6c for electrically insulating the first electrode 6a and the second electrode 6b.

When the measuring voltage is applied to the pair of electrodes including the first electrode 6a and the second electrode 6b by the voltage application portion 6d, a current flows through the kneading substance which comes into contact with the first electrode 6a and the second electrode 6b. Then, the electrical characteristic measurement unit 6 obtains an electrical characteristic value of the current flowing through the kneading substance. Here, the electrical characteristic value is not particularly limited as long as the electrical characteristic value is a parameter indicating conductivity of the current flowing through the kneading substance. For example, the parameter includes a current value, a voltage value, and a resistance value.

An installation place or the number of installed electrical characteristic measurement units 6 is not particularly limited. The installation place is disposed in at least one of the input port lid portion 2g, the discharge port lid portion 2h, the semi-cylindrical left wall portion 2c, the semi-cylindrical right wall portion 2d, the front wall portion 2e, and the rear wall portion 2f of the casing 2. For example, as illustrated in FIG. 5A, the installation place of the electrical characteristic measurement unit 6 maybe a curved surface portion on the mixing chamber side surface in the input port lid portion 2g, the discharge port lid portion 2h, the semi-cylindrical left wall portion 2c, and the semi-cylindrical right wall portion 2d of the casing 2. Alternatively, as illustrated in FIG. 5B, the installation place of the electrical characteristic measurement unit 6 maybe a planar portion on the mixing chamber side surface in the front wall portion 2e and the rear wall portion 2f of the casing 2. It is preferable that the electrical characteristic measurement unit 6 is installed at a position to which the same pressure as the pressure value measured in the pressure measurement unit 5 is applied. For example, in a case where the pressure measurement unit 5 is installed in the curved surface portion, it is preferable that the electrical characteristic measurement unit 6 is installed in the curved surface portion. In a case where the pressure measurement unit 5 is installed in the planar portion, it is preferable that the electrical characteristic measurement unit 6 is installed in the planar portion. From a viewpoint of properly indicating the pressure applied to the kneading substance and accurately determining the dispersed state, it is particularly preferable to install the pressure measurement unit 5 and the electrical characteristic measurement unit 6 in the curved surface portion.

It is preferable that the first electrode 6a and the second electrode 6b which are the pair of electrodes of the electrical characteristic measurement unit 6 are disposed parallel to each other along the shaft portion 3a of the rotor 3. The kneading substance is moved to turn around the rotor 3 by the rotation of the rotor 3. Accordingly, when the pair of electrodes is disposed around the shaft portion 3a of the rotor 3, the kneading substance moves between the electrodes. Therefore, the moving speed of the kneading substance is changed depending on the number of rotations (rotation speed) of the rotor 3. Accordingly, a distance of the kneading substance which comes into contact with the pair of electrodes varies. On the other hand, when the pair of electrodes is disposed parallel to each other along the shaft portion 3a of the rotor 3, the distance of the kneading substance which comes into contact with the pair of electrodes is constant even if the number of rotations of the rotor 3 is changed. Accordingly, the electrical characteristic value can be accurately measured.

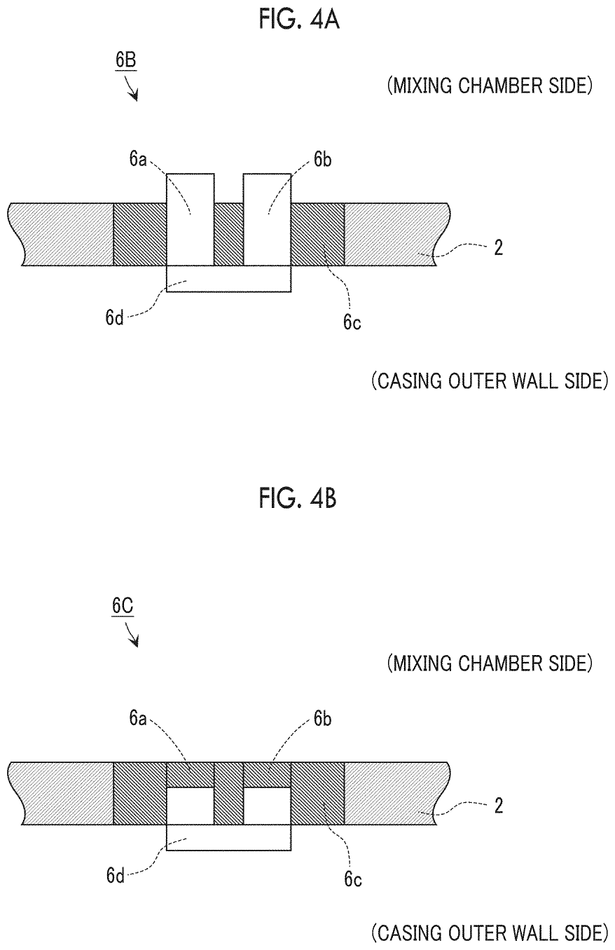

A material or a shape of the first electrode 6a and the second electrode 6b is not limited as long as the electric resistance value of the kneading substance can be measured inside the mixing chamber 4. For example, the material of the first electrode 6a and the second electrode 6b is a metal round bar or square bar. As the shape of the first electrode 6a and the second electrode 6b, for example, as illustrated in FIG. 3, a tip of the first electrode 6a and the second electrode 6b which are in contact with the kneading part maybe flush with the inner surface of the mixing chamber 4. As illustrated in FIG. 4A, the tip of the first electrode 6a and the second electrode 6b may protrude from the inner surface of the mixing chamber 4 to the mixing chamber 4 side. As illustrated in FIG. 4B, the tip of the first electrode 6a and the second electrode 6b may be retreated from the inner surface of the mixing chamber 4 in a direction to a casing outer wall. In a case where the tip is retreated in the direction to the casing outer wall as illustrated in FIG. 4B, a recessed portion is formed on an inner wall of the mixing chamber 4, thereby causing a possibility that the recessed portion may be clogged by the kneading substance. Therefore, it is preferable that the tip of the electrode is flush with the inner surface of the mixing chamber 4 or protrudes to the mixing chamber 4 side. Furthermore, when the tip of the electrode is flush with the inner surface of the mixing chamber 4, there is an advantage in that unintentional shearing of the kneading substance does not occur during the kneading.

The material or the disposition of the insulating member 6c is not particularly limited as long as the first electrode 6a and the second electrode 6b can be insulated from each other. As the material of the insulating member 6c, for example, a resin member having great electric resistance is used. The insulating member 6c is also disposed between the first electrode 6a and the second electrode 6b, and the casing 2.

The electrical characteristic measurement unit 6 transmits the electrical characteristic value relating to the current flowing between the first electrode 6a and the second electrode 6b, to the determination unit 8. The determination unit 8 determines the dispersed state of the conductive dispersoid dispersed in a non-conductive material, based on the electrical characteristic value. The electric resistance value of the kneading substance is constant as the kneading substance is kneaded and the conductive dispersoid is uniformly dispersed. Accordingly, for example, the electric resistance value of the kneading substance is measured. In this manner, the dispersed state of the dispersoid contained in the kneading substance can be directly determined.

It is recognized that a relationship between the electrical characteristic value and the dispersed state varies depending on the pressure value or the temperature value of the kneading substance. It is presumed as follows. A phenomenon in which the relationship between the electrical characteristic value and the dispersed state varies depending on the pressure value of the kneading substance is due to a fact that the pressure of the kneading substance is applied to compress the kneading substance and the distance of the conductive dispersoid contained in the non-conductive material varies. That is, when the pressure is applied to the kneading substance, the distance of the conductive dispersoid is shortened, and the electric resistance value decreases. It is presumed as follows. A phenomenon in which the relationship between the electrical characteristic value and the dispersed state varies depending on the temperature value of the kneading substance is due to a fact that the electric resistance value of the resin decreases when the temperature value increases. Accordingly, the determination unit 8 accurately determines the dispersed state of the kneading substance by using the pressure value, the temperature value, or both the values so as to correct the relationship between the electrical characteristic value and the dispersed state.

From a viewpoint of using the pressure value or the temperature value so as to correct the relationship between the electrical characteristic value and the dispersed state, it is preferable to obtain the electrical characteristic value, the pressure value, and the temperature value for the kneading substance in the same state. Accordingly, it is preferable that the electrical characteristic measurement unit 6, the pressure measurement unit 5, and the temperature measurement unit 7 are disposed close to each other. Furthermore, it is preferable to adopt the following configuration. The electrode portion of the electrical characteristic measurement unit 6 has a cylindrical shape. The pressure receiving portion of the pressure measurement unit 5 or the heat sensitive portion of the temperature measurement unit 7 is disposed inside the electrode portion having the cylindrical shape. The electrical characteristic measurement unit 6 and the pressure measurement unit 5 or the temperature measurement unit 7, or a compound measurement unit in which both of these are integrated with each other are provided. The shape of the electrode portion is not particularly limited. For example, the shape of the electrode portion includes a circular cylindrical shape, an elliptical cylindrical shape, and a square cylindrical shape. The shape of the pressure receiving portion or the heat sensitive portion disposed inside the electrode portion is not particularly limited. For example, the shape includes a columnar shape, an elliptical columnar shape, and a prismatic shape.

When the electrical characteristic measurement unit 6, the pressure measurement unit 5, and the temperature measurement unit 7 are disposed close to each other, a positional relationship thereof is not particularly limited. However, it is preferable that the electrical characteristic measurement unit 6, the pressure measurement unit 5, and the temperature measurement unit 7 are disposed parallel to each other along the shaft portion 3a of the rotor 3. In this manner, for the kneading substance in the same state, it is possible to simultaneously measure the electrical characteristic value by using the electrical characteristic measurement unit 6, the pressure value by using the pressure measurement unit 5, and the temperature value by using the temperature measurement unit 7.

### Determination Unit

The determination unit 8 is electrically connected to the pressure measurement unit 5, the electrical characteristic measurement unit 6, and the temperature measurement unit 7, and receives the electrical characteristic value measured by the electrical characteristic measurement unit 6, the pressure value measured by the pressure measurement unit 5, and the temperature value measured by the temperature measurement unit 7. Based on the electrical characteristic value measured by the electrical characteristic measurement unit 6, the pressure value measured by the pressure measurement unit 5, and the temperature value measured by the temperature measurement unit 7, the determination unit 8 determines the dispersed state of the kneading substance, and displays a progress of the kneading work.

The determination unit 8 may determine the dispersed state of the kneading substance, based on a result of a preliminary test. The relationship between the state of the kneading substance, the electrical characteristic value, the pressure value, and the temperature value may vary depending on a combination of the non-conductive material and the dispersoid. Accordingly, it is desirable that the electrical characteristic value, the pressure value, and the temperature value in a desired dispersed state are measured in advance for each composition of the kneading material. In particular, in a case where the non-conductive material is a natural product, there is a quality difference between lots. Accordingly, it is preferable to perform a preliminary test. In this manner, the determination unit 8 can give an instruction to complete the kneading within an optimal kneading time, and thus, work efficiency can be improved.

Information may be transmitted between the determination unit 8, the electrical characteristic measurement unit 6, the pressure measurement unit 5, and the temperature measurement unit 7 by using communication means directly connected through a cable or by using wireless communication means.

According to the above-described characteristics, while the kneading material input to the casing 2 is kneaded by using the rotating motion of the rotor 3, the kneading device 1A according to the present invention causes the pressure measurement unit 5, the temperature measurement unit 7, and the electrical characteristic measurement unit 6 to measure the electrical characteristic value, the pressure value, and the temperature value of the kneading substance, determines the dispersed state by using the electrical characteristic value, and performs the correction using the pressure value and the temperature value. In this manner, it is possible to accurately determine the dispersed state of the kneading substance when determining the dispersed state of the conductive dispersoid dispersed in the non-conductive material. Accordingly, when the dispersed state of the kneading substance is evaluated, sampling work is not required, and a kneading operation can be efficiently performed.

In the embodiment, the conductive dispersoid is used as the dispersoid. However, the non-conductive dispersoid can also be used. In this case, for example, as an alternative of the electrical characteristic measurement unit, the dispersed state maybe determined so that the dispersoid is detected using an optical method, and the correction may be performed using the pressure value or the temperature value.

### Another Embodiment

A kneading device 1B according to another embodiment of the present invention has a compound measurement unit 9 in which the pressure measurement unit 5 and the electrical characteristic measurement unit 6 are integrated with each other. Except for the pressure measurement unit 5 and the electrical characteristic measurement unit 6, the kneading device 1B according to another embodiment is the same as the kneading device 1A according to the above-described embodiment. Therefore, the compound measurement unit 9 in which the pressure measurement unit 5 and the electrical characteristic measurement unit 6 are integrated with each other will be described.

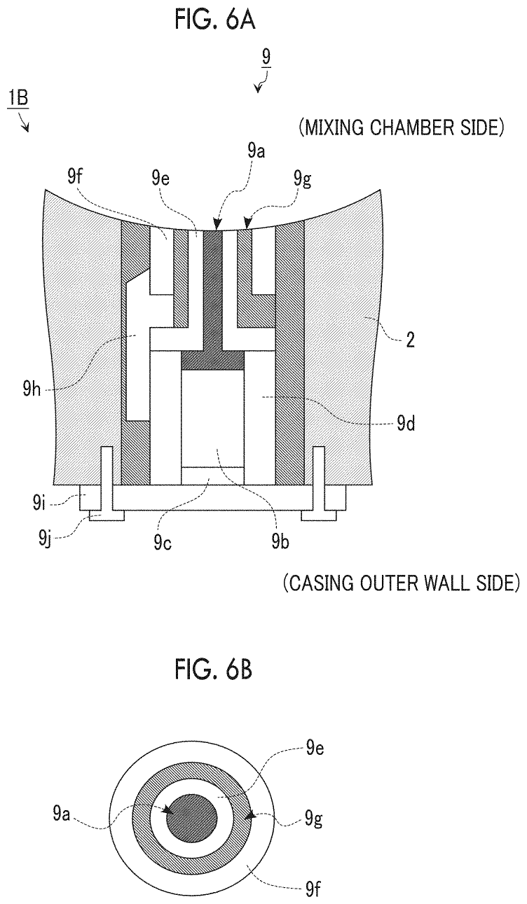

FIG. 6A is a sectional view for describing a structure of the compound measurement unit 9. In the compound measurement unit 9, a pressure receiving portion 9a is disposed at a place where the mixing chamber side surface of the casing 2 comes into contact with the kneading substance. A lower portion of the compound measurement unit 9 includes a pressure measurement unit which has a buffering portion 9b, a pressure sensor 9c, and a guide 9d surrounding a peripheries thereof. The compound measurement unit 9 includes an electrical characteristic measurement unit in which a cylindrical first electrode 9e and a cylindrical second electrode 9f are disposed around the pressure receiving portion 9a to be separated from each other by an insulating member 9g, and which has a voltage application portion 9h for applying a measuring voltage between the first electrode 9e and the second electrode 9f. The compound measurement unit 9 is installed in the casing 2 by using a presser plate 9i and a bolt 9j. The pressure measurement unit and the electrical characteristic measurement unit of the compound measurement unit 9 are respectively and electrically connected to the determination unit 8.

The compound measurement unit 9 senses the pressure generated when the kneading substance during the kneading comes into contact with the pressure receiving portion 9a by using the pressure sensor 9c via the buffering portion 9b, and measures the electrical characteristic value of the current flowing through the kneading substance between the first electrode 9e and the second electrode 9f. In this manner, the pressure value and the electrical characteristic value can be measured at the same place of the kneading substance. Accordingly, while a correlation between the pressure value and the electrical characteristic value is accurately maintained, the dispersed state of the kneading substance can be confirmed.

An installation place or the number of installed compound measurement units 9 is not particularly limited. The installation place is disposed in at least one of the input port lid portion 2g, the discharge port lid portion 2h, the semi-cylindrical left wall portion 2c, the semi-cylindrical right wall portion 2d, the front wall portion 2e, and the rear wall portion 2f of the casing 2. FIG. 6A illustrates an example in which the compound measurement unit 9 is disposed in the curved surface portion of the mixing chamber. However, the compound measurement unit 9 may be disposed in the planar portion of the mixing chamber 4. From a viewpoint of properly applying the pressure to the kneading substance, it is preferable that the compound measurement unit 9 is disposed in the curved surface portion of the mixing chamber.

The material or the shape of the first electrode 9e, the second electrode 9f, and the insulating member 9g of the compound measurement unit 9 is not particularly limited as long as the electrical characteristic value of the kneading substance inside the mixing chamber 4 can be measured. The shape of the compound measurement unit 9 is not limited to a columnar shape as illustrated in the front sectional view in FIG. 6A or the plan view in FIG. 6B. Information may be transmitted between the electrical characteristic measurement unit, the pressure measurement unit, and the determination unit 8 of the compound measurement unit 9 by using communication means directly connected through a cable or by using wireless communication means.

As described above, the kneading device 1B according to the present invention can accurately confirm the state of the kneading substance by measuring the pressure value and the electrical characteristic value of the more localized kneading substance. In this manner, it is possible to improve quality control and work efficiency of a product including the non-conductive material and the conductive dispersoid.

### Another Aspect of Compound Measurement Unit

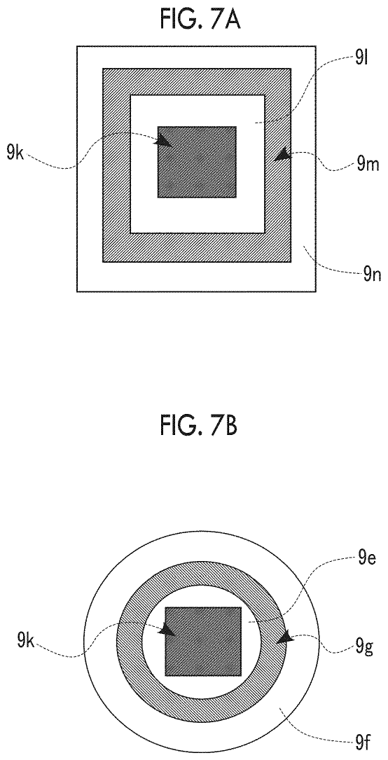

The shape of the compound measurement unit is not limited to the columnar shape illustrated in FIGS. 6A and 6B, and various shapes may be adopted. FIGS. 7A and 7B illustrates another aspect of the compound measurement unit. For example, the compound measurement unit illustrated in FIG. 7A includes a pressure receiving portion 9k having a substantially quadrangular prismatic shape, and a first electrode 9l, a second electrode 9n, and an insulating member 9m which have a substantially quadrangular cylinder shape. The compound measurement unit illustrated in FIG. 7B includes a pressure receiving portion having a substantially quadrangular prismatic shape, and a first electrode 9e, a second electrode 9f, and an insulating member 9g which have a substantially circular cylinder shape.

The kneading device according to the present invention can be used to confirm the dispersed state of the kneading substance during the kneading process in various industrial fields. Specifically, in the kneading process of uniformly dispersing the dispersoid to the non-conductive material such as a polymer material which is a rubber product kneading material, the kneading device according to the present invention can improve quality control and work efficiency.

It should be understood that the invention is not limited to the above-described embodiment, but may be modified into various forms on the basis of the spirit of the invention. Additionally, the modifications are included in the scope of the invention.

What is claimed is:

1. A kneading device for dispersing a dispersoid in a non-conductive material, the kneading device comprising:
a pressure measurement unit that has a pressure receiving portion which comes into contact with a kneading substance formed of the non-conductive material and the dispersoid, and that measures a pressure value applied to the kneading substance formed of the non-conductive material and the dispersoid; and
a determination unit that determines a dispersed state of the dispersoid dispersed in the non-conductive material, based on the pressure value measured by the pressure measurement unit.

2. The kneading device according to claim 1,
wherein the dispersoid is conductive,
wherein the kneading device further comprises an electrical characteristic measurement unit that has an electrode portion which comes into contact with the kneading substance formed of the non-conductive material and the conductive dispersoid, and a voltage application portion which applies a predetermined measuring voltage between a pair of electrodes belonging to the electrode portion, and that measures an electrical characteristic value of the kneading substance, and
wherein the determination unit determines the dispersed state of the conductive dispersoid dispersed in the non-conductive material so that a relationship between the electrical characteristic value measured by the electrical characteristic measurement unit and the dispersed state is corrected using the pressure value measured by the pressure measurement unit.

3. The kneading device according to claim 2, further comprising:
a temperature measurement unit that has a heat sensitive portion which comes into contact with the kneading substance formed of the non-conductive material and the conductive dispersoid, and that measures a temperature value applied to the kneading substance formed of the non-conductive material and the conductive dispersoid,
wherein the determination unit determines the dispersed state of the conductive dispersoid dispersed in the non-conductive material so that a relationship between the electrical characteristic value measured by the electrical characteristic measurement unit and the dispersed state is corrected using the pressure value measured by the pressure measurement unit and the temperature value measured by the temperature measurement unit.

4. The kneading device according to claim 3,
wherein the electrical characteristic measurement unit and the pressure measurement unit are disposed close to each other.

5. The kneading device according to claim 2,
wherein a shape of the electrode portion is cylindrical, and the pressure receiving portion is disposed inside the cylindrical electrode portion.

6. A manufacturing method of a kneading substance in which a dispersoid is dispersed in a non-conductive material, the method comprising:
a pressure measurement step of measuring a pressure value applied to the kneading substance formed of the non-conductive material and the dispersoid; and
a determination step of determining a dispersed state of the dispersoid dispersed in the non-conductive material, based on the pressure value measured in the pressure measurement step.
